(19) United States
(12) Patent Application Publication
(10) Pub. No.: US 2020/0380834 A1
(43) Pub. Date: Dec. 3, 2020

(54) Fraudulent Device Detection System

(71) Applicants: Josh Neeley, San Antonio, TX (US); Troy Morris, New Braunfels, TX (US); William Nance, Seguin, TX (US)

(72) Inventors: Josh Neeley, San Antonio, TX (US); Troy Morris, New Braunfels, TX (US); William Nance, Seguin, TX (US)

(21) Appl. No.: 16/887,469

(22) Filed: May 29, 2020

Related U.S. Application Data
(60) Provisional application No. 62/853,812, filed on May 29, 2019.

(51) Int. Cl. G08B 13/196

(52) U.S. Cl. CPC G08B 13/19684; G08B 13/19665; G08B 13/1966

(57) ABSTRACT

A fraudulent device detection system for a fuel pump. The system includes a sensor housed within a fuel pump. The sensor is placed behind a door of the fuel pump, which is activated when the door is opened. The sensor is connected to a camera. The camera is capable of taking video or pictures. The camera will begin capturing images when the sensor is activated. The camera is connected to a transceiver. The transceiver sends information from the camera to a plurality of storage devices. There is further an alarm trigger attached to the sensor. When the sensor is activated the alarm trigger, triggers an alarm such that a user is made aware of the fuel pump being opened.

### CROSS REFERENCE TO RELATED APPLICATIONS

This application claims the benefit of U.S. Provisional Application No. 62/853,812 filed on May 29, 2019. The above identified patent application is herein incorporated by reference in its entirety to provide continuity of disclosure.

### BACKGROUND OF THE INVENTION

The present invention relates to a system for detecting installation of unauthorized credit card reading machines. More particularly, the present invention provides a system for detecting when a fuel pump door is open, and a person is entering the fuel pump.

Credit cards are more common than cash when paying for items in today's world. The simplicity of having money on hand without carrying cash is something many enjoy. Credit cards have come a long way when it comes to security. However, as security improves thieves become more advanced as well. This means that even when cards move to new magnetic strips and chips, card readers can be advanced to still read these devices.

Everyone needs to obtain fuel for one reason or another. Many people use a credit card to purchase this fuel. Fuel pumps are an easy target for a thief to place a credit card Skimmer in an attempt to steal credit card information. This is because fuel pumps are often unsupervised and easy targets. Further, fuel pumps do not hold money and as such are relatively unprotected.

In order to place a card skimmer in a gas pump, the door is pried open and a card skimmer is placed within the machine. This is extremely hard to detect because from most cameras placed at a gas station, it appears an individual is simply fueling their car. Once the card skimmer is in place, the fuel pump door is closed and everything looks normal. This means that without advanced security card skimmers can be placed and many unsuspecting people can have their card information stolen.

Consequently, there is a need in for an improvement in the art of systems for detecting unauthorized credit card skimmers. The present invention substantially diverges in design elements from the known art while at the same time solves a problem many people face when feeling safe when using their credit cards. In this regard the present invention substantially fulfills these needs.

### SUMMARY OF THE INVENTION

The present invention provides a fraudulent device detection system wherein the same can be utilized for providing convenience for the user when using a fraudulent device detection system. The present system comprises a fraudulent device detection system, comprising: A sensor, operably connected to a recording device. A recording device is operably coupled to a plurality of storage devices. A computer connected to the system wherein the computer houses at least one of the plurality of storage devices. The computer further has a transceiver to talk to the system. An alarm is operably coupled to the sensor.

Another object of the fraudulent device detection system is to include an alarm trigger wherein an alarm sounds when the sensor is activated.

Another object of the fraudulent device detection system is to include a mobile device capable of receiving notifications from the system.

Another object of the fraudulent device detection system is to include an alarm trigger sends an alarm to a mobile device.

Another object of the fraudulent device detection system is to include a mobile device allows a user to view footage from the camera.

Another object of the fraudulent device detection system is to be included within the housing of a fuel pump.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the fraudulent device detection system installed in a fuel pump.

FIG. 2 shows a diagram of an embodiment of the fraudulent device detection system.

FIG. 3 shows a wiring diagram of an embodiment of the fraudulent device detection system.

FIG. 4 shows a flow chart of an embodiment of a method for using the fraudulent device detection system.

### DETAILED DESCRIPTION OF THE INVENTION

Reference is made herein to the attached drawings. Like reference numerals are used throughout the drawings to depict like or similar elements of the fraudulent device detection system. For the purposes of presenting a brief and clear description of the present invention, a preferred embodiment will be discussed as used for the fraudulent device detection system. The figures are intended for representative purposes only and should not be considered to be limiting in any respect.

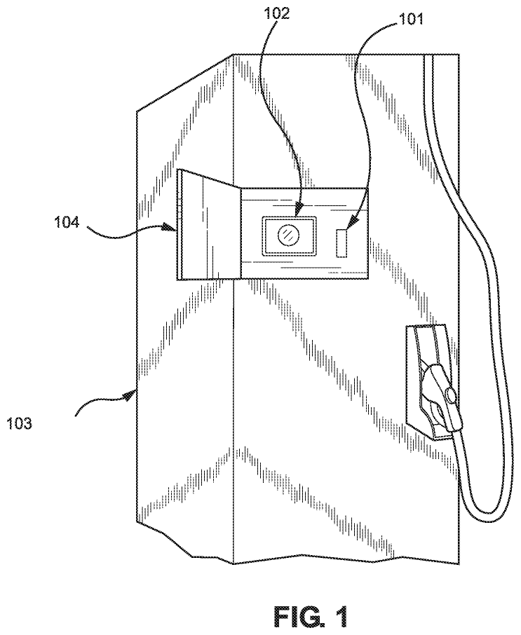

Referring now to FIG. 1, there is shown a perspective view of an embodiment of the fraudulent device detection system installed in a fuel pump. The fraudulent device detection system includes a sensor 101. In one embodiment, the sensor 101 is a motion sensor. In another embodiment the sensor 101 is a light sensor. In yet a further embodiment the sensor is a temperature sensor. The sensor 101 is coupled to a recording device. In one embodiment the recording device is a camera 102. In one embodiment the camera is a video camera. In one embodiment the camera is configured to talk night vision pictures or video. The sensor 101 is configured to activate the camera 102 when the sensor 101 is activated.

The sensor 101 and the camera are to be placed in such a position that the camera will be activated when a credit card reader is accessed or manipulated. In one embodiment, the camera 102 and the sensor 101 are located within a fuel pump housing 103. Specifically, they are located behind a maintenance door 104 of the fuel pump housing 103. The sensor 101 is pointed at the maintenance door 104 so that when the maintenance door is opened the camera 102 will record.

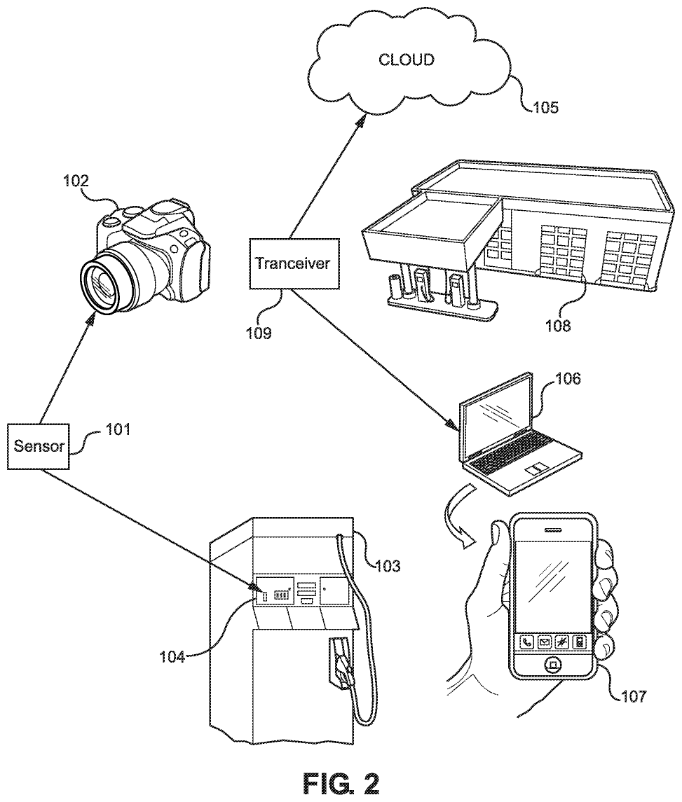

Referring now to FIG. 2, there is shown a diagram of an embodiment of the fraudulent device detection system. In addition to the sensor 101 and the camera 102, the system includes a transceiver 109 connected to the camera 102. In one embodiment, the transceiver 109 is a wireless transceiver. In another embodiment, the transceiver 109 is a wired transceiver. The transceiver 109 is operably connected to a cloud computing server 105. The cloud computing server 105 is capable of storing information received from the transceiver 109. This information includes pictures, videos, time stamps, and other associated information.

In one embodiment, the transceiver 109 is further coupled to a mobile device 107. The mobile device 107 is configured to display information received from the alert system. In a further embodiment, the mobile device 107 is configured to display an alert. The alert will trigger when the sensor 101 is triggered.

In another embodiment, the transceiver 109 is connected to a computer 106. In one embodiment the computer 106 is configured to display information received from the transceiver 109. In a further embodiment the computer 106 is configured to rise an alarm to alert that the sensor 101 has been triggered. In yet another embodiment the computer 106 is configured to store information received by the transceiver 109.

In yet another embodiment, the transceiver 109 is connected to a system in a service station 108. In one embodiment the service station 108 is configured to display information received from the transceiver 109. In a further embodiment the service station is configured to rise an alarm to alert a station 108 occupant to the fact that a sensor 101 has been triggered.

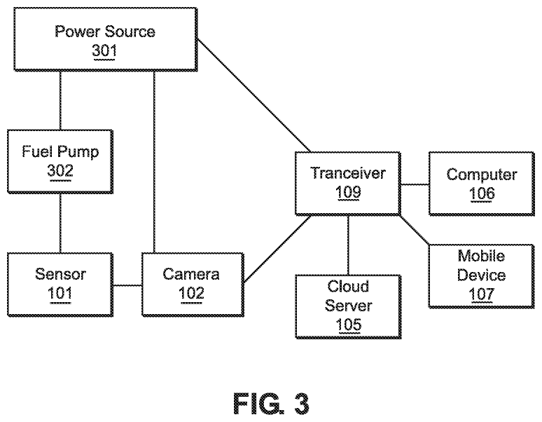

Referring now to FIG. 3, there is shown a wiring diagram of an embodiment of the fraudulent device detection system. The fraudulent device detection system includes a power source 301. In one embodiment, the power source 301 is a battery. In another embodiment, the power source 301 is wired into a ground electric line. In one embodiment the power source 301 is wired into a fuel pump 302, into the fuel pump 302. In one embodiment, there is a sensor 101 wired into the fuel pump 302. A camera 102 is attached to the power source 301 and the sensor 101. In one embodiment the camera is located within the housing of the fuel pump 302.

A transceiver 109 is coupled to the power source 301 and the camera 304. In one embodiment, the transceiver is a wireless transceiver. In another embodiment, the transceiver 109 is wired into the fuel pump. The transceiver 109 can send data to a cloud server 105, a computer 106, and or a mobile device 107. Each of these devices is capable of data storage. The mobile device 107 and computer 106 are further capable of allowing the user to review the data.

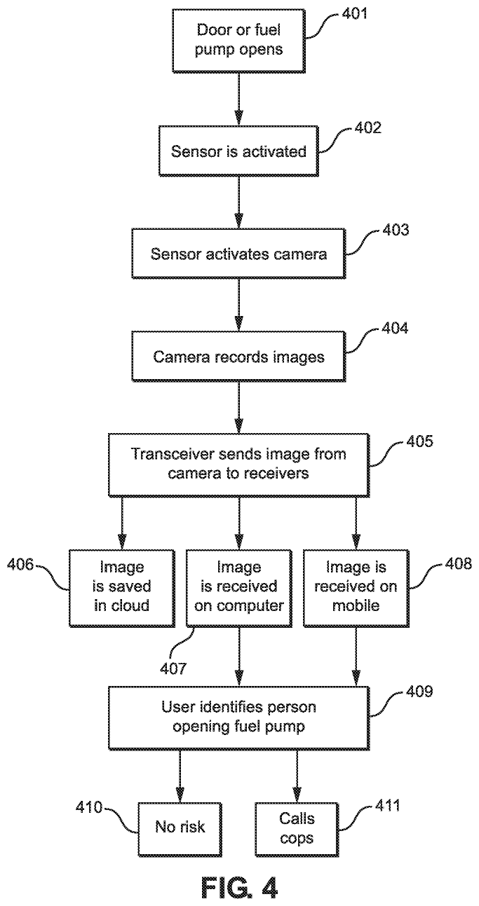

Referring now to FIG. 4, there is shown a flow chart of an embodiment of a method for using the fraudulent device detection system. In use, the system will operate in the following sequence or a similar one thereto. The system will start to function when a door to a fuel pump is open 401 and the sensor is activated 402. When the sensor is activated 402, the sensor triggers a camera 403. The camera will begin recording 404. In one embodiment, the camera will record images. In another embodiment, the camera will record video.

Once the images or video is captures 404 the transceiver will send the data from the camera to at least one of a plurality of devices 405. When the transceiver sends the imaged to the receivers an alarm is also sent. The alarm will notify an individual to the presence of someone at the fuel pump. A data can be saved to a cloud server 406. The data can further be sent to a computer 407 and or a mobile device 408. Once the data is received a user can view the data and determine if the opening of the fuel pump poses a risk to security 409. If there is no risk the process ends 410. If a risk is posed, the user can then intervene 411.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A fraudulent device detection system, comprising:
a sensor, operably connected to a recording device;
a recording device operably coupled to a plurality of storage devices;
a computer housing at least one of the plurality of storage devices, wherein the computer has a transceiver;
an alarm operably coupled to the sensor.

2) The fraudulent device detection system of claim 1, further comprising an alarm trigger wherein an alarm sounds when the sensor is activated.

3) The fraudulent device detection system of claim 1, further comprising a mobile device capable of receiving notifications from the transceiver of the system.

4) The fraudulent device detection system of claim 2, wherein the alarm trigger sends an alarm to a mobile device.

5) The fraudulent device detection system of claim 4, wherein the mobile device allows a user to view footage from the camera.

6) A fraudulent device detection system located within a fuel pump, the system comprising:
a sensor located within a housing of a fuel pump, wherein the sensor is activated when a door of the fuel pump housing is opened;
the sensor is operably coupled to a recording device;
a recording device operably coupled to a plurality of storage devices;
a computer housing a storage device, wherein the computer has a transceiver;
an alarm operably coupled to the sensor.

7) The fraudulent device detection system of claim 6, further comprising an alarm trigger wherein an alarm sounds when the sensor is activated.

8) The fraudulent device detection system of claim 6, further comprising a mobile device capable of receiving notifications from the system.

9) The fraudulent device detection system of claim 7, wherein the alarm trigger sends an alarm to a mobile device.

10) The fraudulent device detection system of claim 9, wherein the mobile device allows a user to view footage from the camera.
